(19) United States
(12) Patent Application Publication
(10) Pub. No.: US 2026/0364615 A1
(43) Pub. Date: Nov. 19, 2026

(54) SHOWER SYSTEM

(71) Applicant: Fujian Onlytop Sanitaryware Co.,Ltd., ZHANGZHOU (CN)

(72) Inventors: Jiaping Xu, ZHANGZHOU (CN); Kunjing Fan, ZHANGZHOU (CN)

(73) Assignee: Fujian Onlytop Sanitaryware Co.,Ltd., ZHANGZHOU (CN)

(21) Appl. No.: 19/679,725

(22) Filed: May 17, 2026

(30) Foreign Application Priority Data
May 16, 2025 (CN) 202510633329X

(51) Int. Cl. B05B 1/18; A47K 3/28; B05B 1/16; B05B 15/62

(52) U.S. Cl. CPC B05B 1/1894; A47K 3/28; B05B 1/1636; B05B 1/189; B05B 1/1892; B05B 15/62

(57) ABSTRACT

A shower system comprises an overhead showerhead and a handheld showerhead. The overhead showerhead includes a first connecting structure on a front side thereof, and the handheld showerhead includes a second connecting structure. The first connecting structure includes a first magnetic coupling portion and a positioning projection. The second connecting structure includes a second magnetic coupling portion on a back side of the handheld showerhead and a positioning engagement portion on an outer peripheral wall of an outlet portion of the handheld showerhead. During mounting, the positioning engagement portion is visible to a user, thereby allowing visual alignment with the positioning projection. When the handheld showerhead is mounted to the overhead showerhead, the positioning projection is received in the positioning engagement portion, and the second magnetic coupling portion is magnetically coupled to the first magnetic coupling portion, thereby stabilizing the connection.

### CROSS-REFERENCE TO RELATED APPLICATIONS

This application claims priority to Chinese Patent Application No. 202510633329.X, filed on May 16, 2025, the entire contents of which are incorporated herein by reference.

### TECHNICAL FIELD

The present disclosure relates to sanitary ware, and more particularly to a shower system.

### BACKGROUND

At present, some shower systems available on the market have a handheld showerhead that is directly hung on an overhead showerhead. For example, as shown in FIGS. 21 and 22 of U.S. Patent Application Publication No. US 2021/0053083 A1, a structure of the handheld showerhead used for connection with the overhead showerhead may be referred to as a second connecting structure, and a structure of the overhead showerhead used for connection with the handheld showerhead may be referred to as a first connecting structure. Such shower systems generally have the following drawback. When a user returns the handheld showerhead to the overhead showerhead, the user cannot see the second connecting structure on the back side of the handheld showerhead, that is, the side opposite to the water outlet side of the handheld showerhead. When the handheld showerhead is relatively close to the overhead showerhead, the user also cannot see the first connecting structure on the front side of the overhead showerhead, that is, the water outlet side of the overhead showerhead. In other words, the user cannot directly see whether the second connecting structure is aligned with the first connecting structure. As a result, when the user attempts to return the handheld showerhead, there is a relatively high probability that the second connecting structure will not be aligned with the first connecting structure, requiring several attempts. This is inconvenient to the user and also increases the number of collisions and scratches between the handheld showerhead and the overhead showerhead.

### SUMMARY

A primary objective of the present disclosure is to provide a shower system that enables a user to return a handheld showerhead to an overhead showerhead more easily and quickly while ensuring a stable connection between the handheld showerhead and the overhead showerhead.

To address the above technical problem, the present disclosure provides an overhead showerhead, comprising an overhead outlet portion and a connecting portion arranged side by side, the overhead showerhead having a back side provided with a water inlet port configured to be connected to an external water outlet pipe, the connecting portion having a front side provided with a first connecting structure, the first connecting structure comprising a first magnetic coupling portion and a positioning projection; and a handheld showerhead, comprising a handheld outlet portion, an outer peripheral wall of the handheld outlet portion, and a second connecting structure configured to connect to the first connecting structure, the second connecting structure comprising a second magnetic coupling portion disposed on a back side of the handheld showerhead and a positioning engagement portion disposed on the outer peripheral wall; and the positioning engagement portion is exposed to a line of sight of a user while the handheld showerhead is being moved toward and mounted to the overhead showerhead, so that the user can visually align the positioning engagement portion with the positioning projection, and when the handheld showerhead is mounted to the overhead showerhead, the positioning projection is received in the positioning engagement portion to limit movement of the handheld showerhead relative to the overhead showerhead at least in a vertical direction, and the second magnetic coupling portion is magnetically coupled to the first magnetic coupling portion.

With the above structure, because the overhead showerhead and the handheld showerhead are respectively provided with the positioning projection and the positioning engagement portion that are visible to the user, when the user returns the handheld showerhead to the overhead showerhead, the user can directly see whether the positioning engagement portion is aligned with the positioning projection, and can easily and quickly hang the handheld showerhead in an accurate position. This reduces unnecessary collisions and scratches between the handheld showerhead and the overhead showerhead during alignment and mounting. In addition, the magnetic coupling between the second magnetic coupling portion and the first magnetic coupling portion ensures that the handheld showerhead is stably hung on the overhead showerhead.

In a preferred embodiment, the connecting portion extends downward from a lower portion of a peripheral side of the overhead outlet portion . A back side of the overhead showerhead has a rearwardly protruding portion. The water inlet port is disposed at an end of the rearwardly protruding portion away from the front side of the overhead showerhead. The connecting portion or the rearwardly protruding portion is further provided with a water outlet port configured to supply water to the handheld showerhead, and the water outlet port is in fluid communication with the handheld showerhead through a connecting conduit. The connecting portion or the rearwardly protruding portion is further provided with a first switching assembly configured to selectively place the water inlet port in fluid communication with the water outlet port and/or the overhead outlet portion. The water outlet port and the first switching assembly allow the handheld showerhead to receive water through the water inlet port of the overhead showerhead, thereby simplifying the installation structure of the shower system and providing a more concise appearance.

In a preferred embodiment, as viewed from a front side of the overhead showerhead, the water inlet port, the water outlet port, and the first connecting structure are arranged along a first central axis of the overhead showerhead. The positioning projection is located above the first magnetic coupling portion. The second connecting structure is arranged along a second central axis of the handheld showerhead. The positioning engagement portion is disposed at an upper portion of the outer peripheral wall of the handheld outlet portion of the handheld showerhead, and the second magnetic coupling portion is located below the positioning engagement portion. When the handheld showerhead is stably connected to the overhead showerhead, the first central axis and the second central axis coincide or substantially coincide in the front view. By arranging the water inlet port, the water outlet port, and the first connecting structure along the first central axis of the overhead showerhead, and by arranging the second connecting structure along the second central axis of the handheld showerhead, the center of gravity of the shower system formed by the overhead showerhead and the handheld showerhead in the mounted state can be located on the first central axis or the second central axis. This helps prevent the shower system from yawing clockwise or counterclockwise about the water inlet port as a rotation axis.

In a preferred embodiment, the positioning projection has a free end extending toward the handheld showerhead, and the free end is turned upward. The positioning engagement portion is a through hole or a C-shaped slot formed in the outer peripheral wall of the handheld outlet portion. When the handheld showerhead is mounted to the overhead showerhead, the positioning projection extends into the positioning engagement portion, and the free end forms a retaining stop for the positioning engagement portion. This configuration further prevents the handheld showerhead from disengaging from the overhead showerhead and therefore ensures connection stability.

In a preferred embodiment, the overhead showerhead comprises a first housing and an overhead-shower water outlet assembly. The first housing comprises a main housing and a cover assembled together. The main housing and the cover jointly form a housing of the connecting portion on one side of the overhead showerhead, and jointly enclose a receiving space for receiving the overhead-shower water outlet assembly on another side of the overhead showerhead. The main housing forms the rearwardly protruding portion in a region forming the connecting portion, or in a region of the overhead outlet portion adjacent to the connecting portion. The water inlet port is disposed at an end of the rearwardly protruding portion away from the front side of the overhead showerhead, and a side wall of the rearwardly protruding portion forms an outwardly extending water outlet port. The first magnetic coupling portion comprises a first magnetic coupling member. The first magnetic coupling member is disposed on a side of the cover facing the main housing, and the cover is provided with a first clearance hole corresponding to the first magnetic coupling member. The second magnetic coupling portion comprises a second magnetic coupling member. The handheld showerhead comprises a second housing and a handheld-shower water outlet assembly. The second housing is provided, at a back side opposite the handheld-shower water outlet assembly, with a second clearance hole. The second magnetic coupling member is disposed in the second housing and at least partially protrudes outward through the second clearance hole. When the handheld showerhead is mounted to the overhead showerhead, opposite sides of the second magnetic coupling member and the first magnetic coupling member are directly magnetically coupled to each other. Such direct magnetic coupling avoids magnetic attenuation caused by intervening sheet material of the overhead showerhead and the handheld showerhead.

### BRIEF DESCRIPTION OF THE DRAWINGS

FIG. 1 is a structural view of a shower system according to Embodiment 1 of the present disclosure.

FIGS. 2A, 2B, and 2C are schematic views respectively showing magnetic coupling between the overhead showerhead and the handheld showerhead of FIG. 1 from different viewing angles.

FIGS. 3A and 3B are exploded views respectively showing the handheld showerhead of FIG. 1 from different viewing angles.

FIGS. 4A, 4B, and 4C are exploded views respectively showing the overhead showerhead of FIG. 1 from different viewing angles.

FIG. 5 is an exploded view of portion A in FIG. 4B.

FIGS. 6A, 6B, and 6C are schematic flow-path diagrams respectively showing water discharge from the handheld showerhead alone, water discharge from the overhead showerhead alone, and simultaneous water discharge from both the handheld showerhead and the overhead showerhead.

FIG. 7 is a structural view of a shower system according to Embodiment 2 of the present disclosure.

FIG. 8 is a schematic view of a handheld showerhead according to Embodiment 3 of the present disclosure.

### DETAILED DESCRIPTION OF EMBODIMENTS

It should be noted that directional terms such as "upper," "lower," "left," "right," "front," and "rear" used in this specification are defined with reference to the shower system of the present disclosure in a normal use posture, using the shower system itself as a reference. Such directional descriptions are provided only to facilitate explanation of structural and assembly relationships, and do not limit the scope of the present disclosure. In this specification, "front side" refers to a side of the overhead showerhead or handheld showerhead at which the water outlet surface faces a shower user, and "back side" refers to a side of the overhead showerhead or handheld showerhead at which the water outlet surface faces away from the shower user.

### Embodiment 1

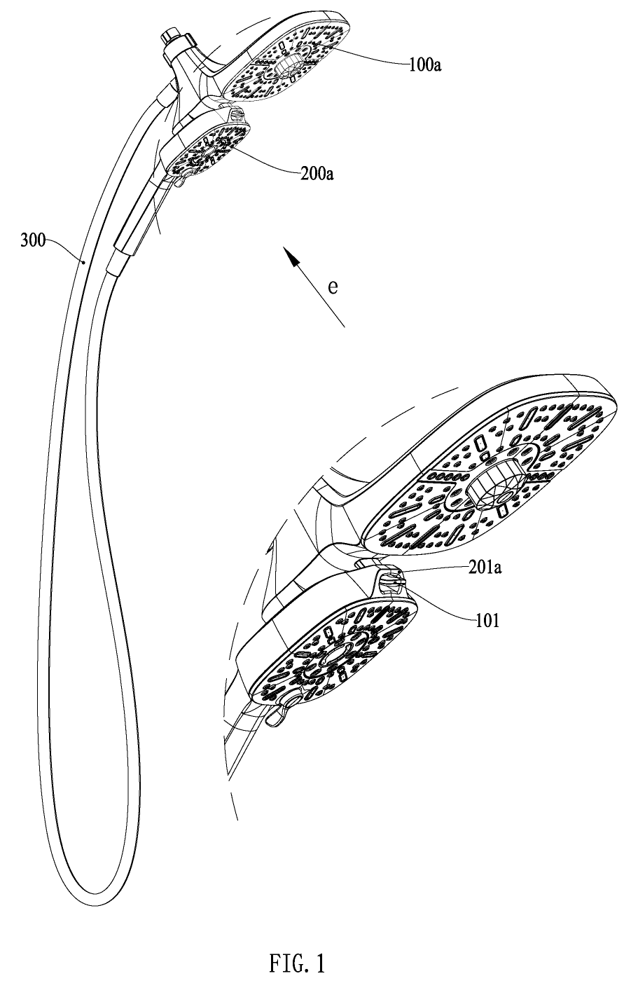

Referring to FIG. 1, in this embodiment, a shower system provided by the present disclosure comprises an overhead showerhead 100a, a handheld showerhead 200a, and a connecting conduit 300. The overhead showerhead comprising an overhead outlet portion p11 and a connecting portion p12 arranged side by side In FIG. 1, the handheld showerhead 200a is magnetically coupled to the overhead showerhead 100a, and the positioning projection 101 on the overhead showerhead 100a extends through the positioning engagement portion 201a on the handheld showerhead 200a.

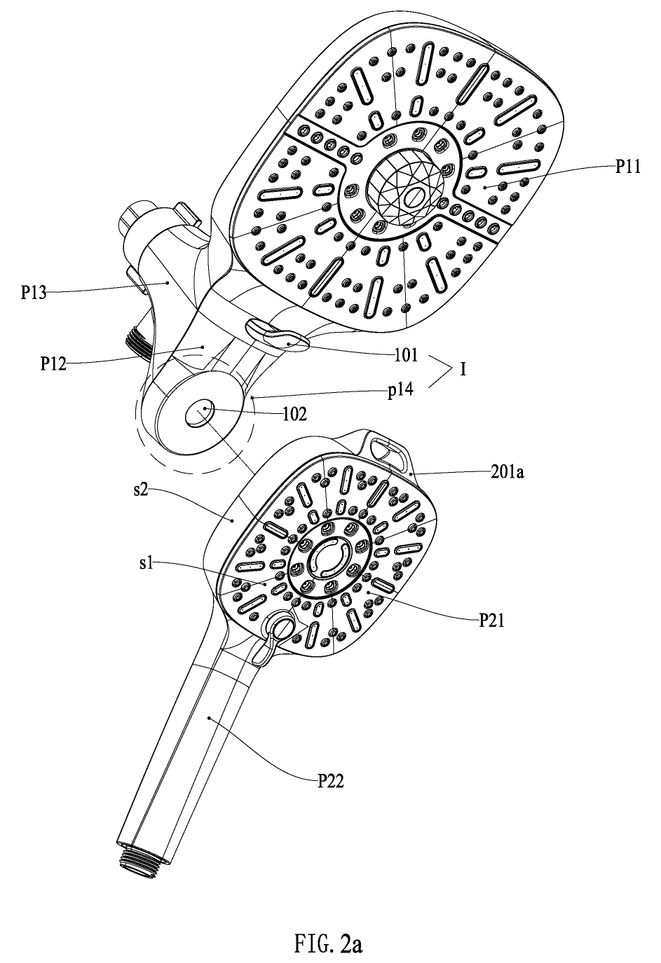

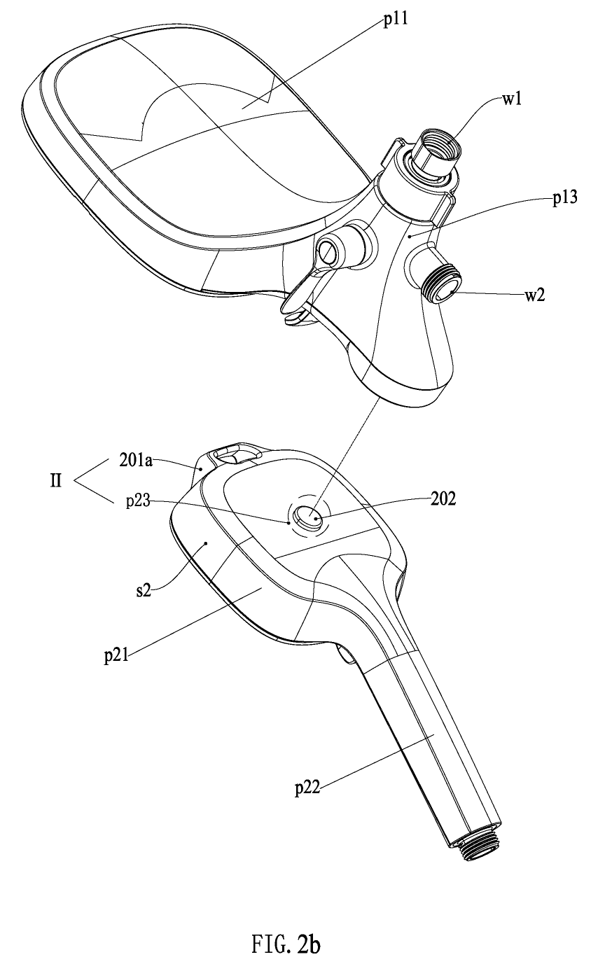

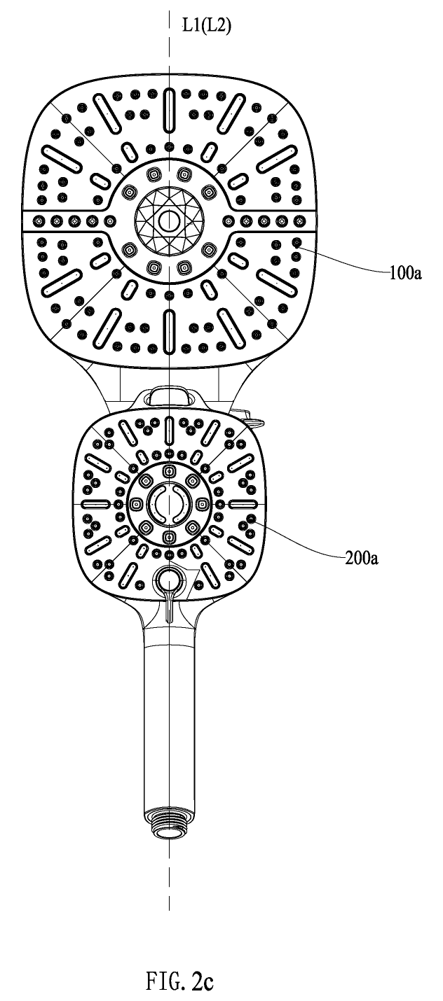

Referring to FIGS. 2A, 2B, 4A, 4B, 4C, and 5, in this embodiment, the overhead showerhead 100a comprises a first housing 110 and an overhead-shower water outlet assembly 120. The first housing 110 comprises a main housing 112 and a cover 113 assembled together; and the main housing 112 and the cover 113 jointly form a housing of the connecting portion on one side of the overhead showerhead 100a and jointly enclose and define a housing of the overhead outlet portion on another side of the overhead showerhead 100a, the housing of overhead outlet portion having a receiving space s5 for the overhead-shower water outlet assembly 120.

Referring to FIG. 2A, the overhead showerhead 100a is provided, on a front side of the connecting portion p12 of the cover 113, with a first connecting structure I configured to connect to the handheld showerhead 200a. The first connecting structure I comprises a first magnetic coupling portion p14 and a positioning projection 101. The positioning projection 101 is located above the first magnetic coupling portion p14. More preferably, the positioning projection 101has a free end extending toward the handheld showerhead 200a, and the free end is turned upward to form a hook shape.

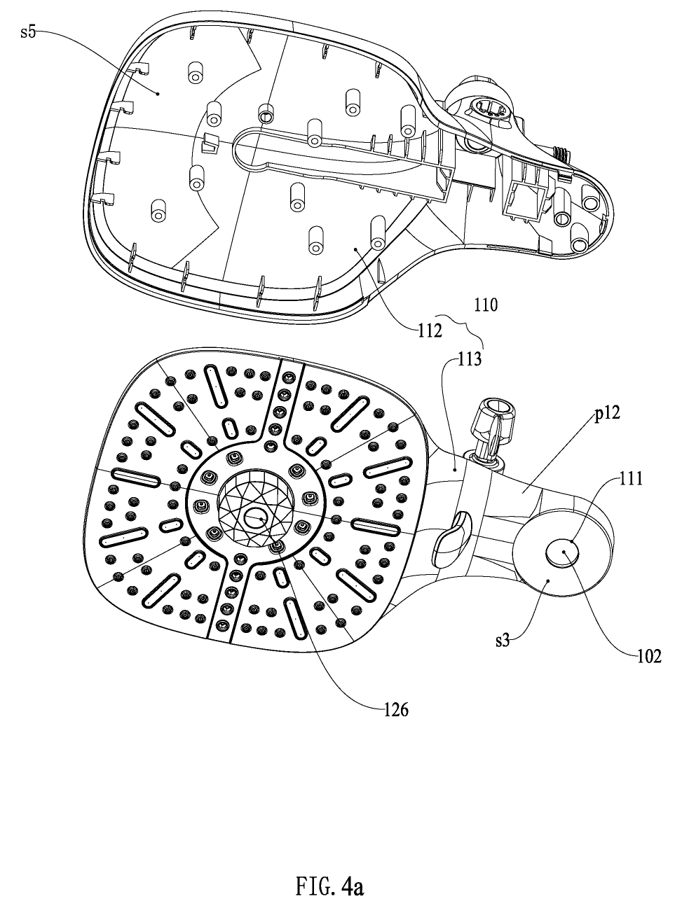

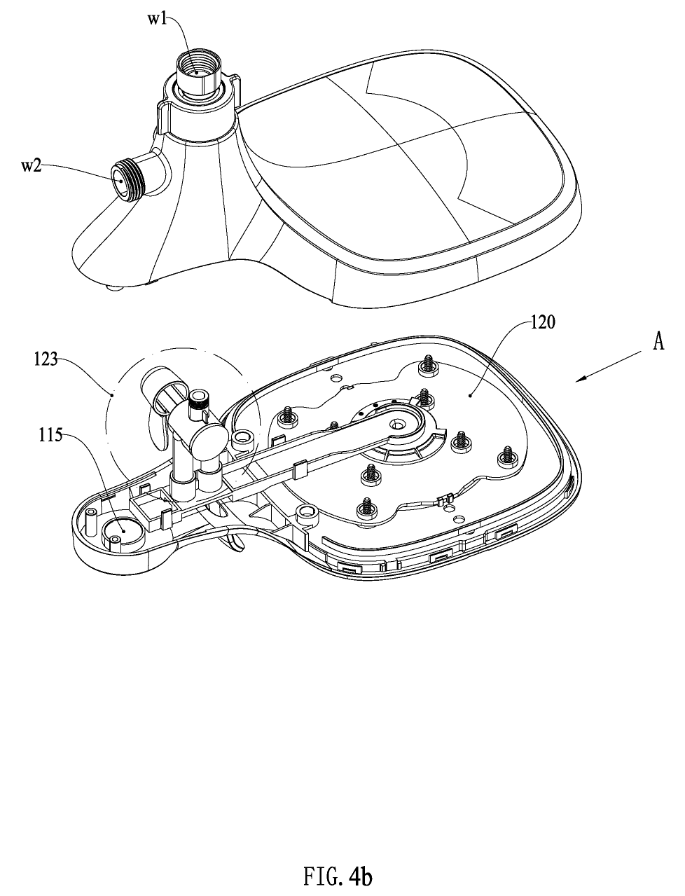

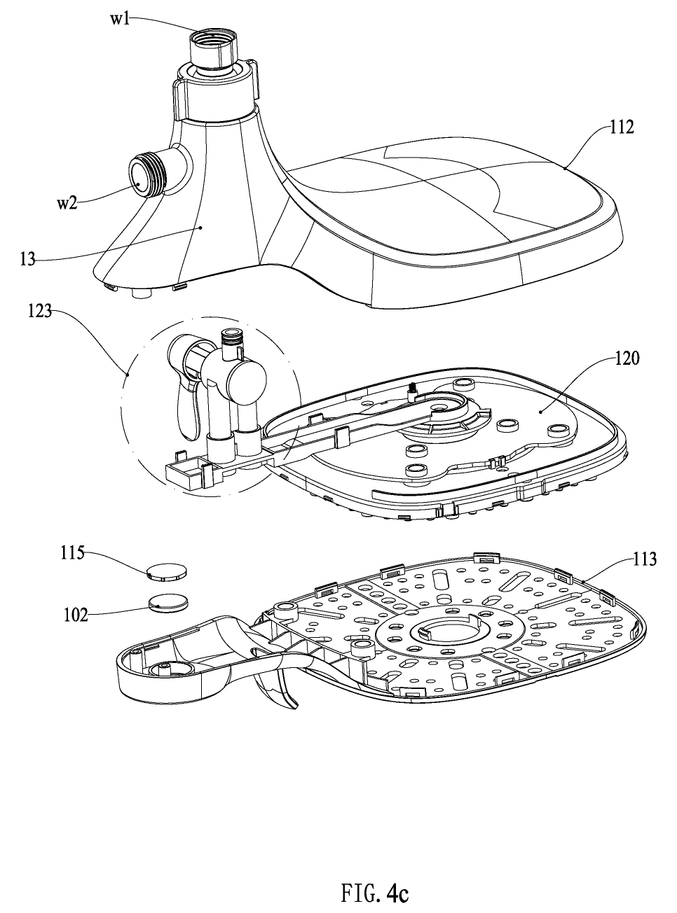

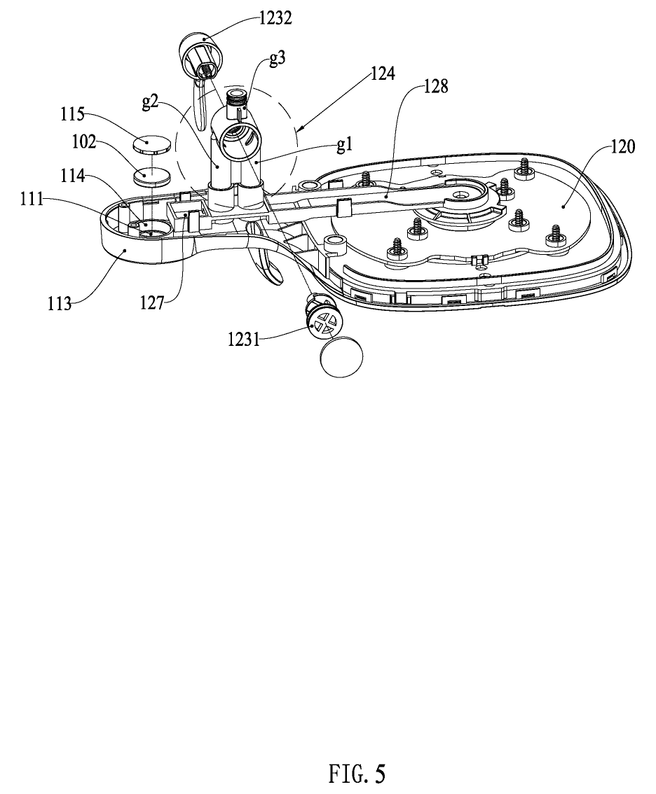

Referring to FIGS. 4A, 4B, 4C, and 5, the first magnetic coupling portion p14 is disposed at a free end of the connecting portion p12 and comprises a first magnetic coupling member 102. The cover 113 is provided with a first clearance hole 111. On a side of the cover 113 facing the main housing 112, a mounting recess 114 is provided at a position corresponding to the first clearance hole 111, and the first clearance hole 111 communicates with the mounting recess 114. The first magnetic coupling member 102 is a circular magnetic coupling member, the mounting recess 114 is a circular mounting recess adapted to the first magnetic coupling member 102, the first clearance hole 111 is a circular hole, and an inner diameter of the first clearance hole 111 is smaller than an outer diameter of the first magnetic coupling member 102. The first magnetic coupling member 102 is disposed in the mounting recess 114. A retaining block 115 is further embedded in the mounting recess 114 by an interference fit, and the retaining block 115 retains the first magnetic coupling member 102 in the mounting recess 114. It may be understood that the first clearance hole 111, the mounting recess 114, the first magnetic coupling member 102, and the retaining block 115 of the cover 113 together form the first magnetic coupling portion p14. The first magnetic coupling member 102 is not limited to a circular shape and may have another shape, in which case the shapes of the first clearance hole 111 and the mounting recess 114 are adaptively adjusted.

More preferably, as shown in FIG. 4A, the first magnetic coupling portion p14 further comprises a first abutting surface s3 formed by the cover 113 around the first clearance hole 111. The first abutting surface s3 is a circular planar surface.

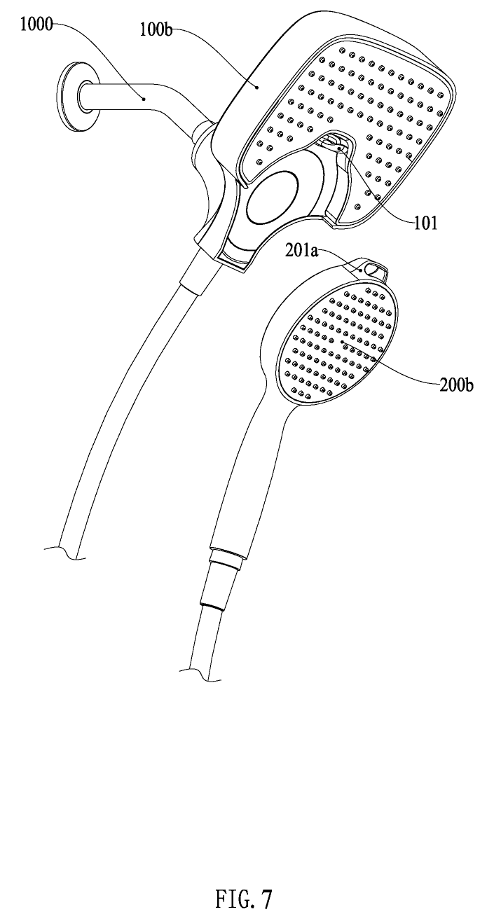

The overhead showerhead 100a has, on a back side of the connecting portion p12 of the main housing 112, a rearwardly protruding portion p13. An end of the rearwardly protruding portion p13 in a direction away from the front side of the connecting portion p12 is provided with a water inlet port w1 configured to be connected to an external water outlet pipe 1000, as shown in FIG. 7. A lower portion of the rearwardly protruding portion p13 is provided with a water outlet port w2 configured to supply water to the handheld showerhead 200a. The water outlet port w2 is in fluid communication with the handheld showerhead 200a through the connecting conduit 300. A side portion of the rearwardly protruding portion p13 is further provided with a first switching assembly 123 configured to selectively place the water inlet port w1 in fluid communication with the water outlet port w2 and/or the overhead outlet portion p11 of the overhead showerhead 100a. In other embodiments, the water outlet port w2 may not be provided on the overhead showerhead 100a, but instead may be provided on a wall, not shown, so that the overhead showerhead 100a and the handheld showerhead 200a receive water independently. In that case, the first switching assembly need not be provided on the overhead showerhead 100a, and may instead be provided on the wall and configured to select whether the overhead showerhead discharges water or the handheld showerhead discharges water. Alternatively, in other embodiments, the rearwardly protruding portion p13 may be moved upward to a region of the overhead outlet portion p11 adjacent to the connecting portion p12, not shown. In this embodiment, as viewed from a front side of the overhead showerhead 100a, namely in the line-of-sight direction indicated by arrow e in FIG. 1, the water inlet port w1, the water outlet port w2, and the first connecting structure I are all arranged along a first central axis L1 of the overhead showerhead 100a, as shown in FIG. 2C.

Referring to FIGS. 4B, 4C, and 5, the first switching assembly 123 comprises a valve body 124, a valve stem 1231, and an operating member 1232 at least partially exposed from the connecting portion p12. The operating member 1232 is drivingly connected to the valve stem 1231. The valve body 124 has a cylindrical inner chamber. A water inlet passage g3, a first water outlet passage g2, and a second water outlet passage g1 are respectively disposed at circumferential positions around the inner chamber on an outer-wall side of the valve body 124, and are fluidly connected to the inner chamber of the valve body 124. The water inlet passage g3 is fluidly connected to the water inlet port w1, the first water outlet passage g2 is fluidly connected to the water outlet port w2, and the second water outlet passage g1 is fluidly connected to a water inlet end of the overhead-shower water outlet assembly 120.

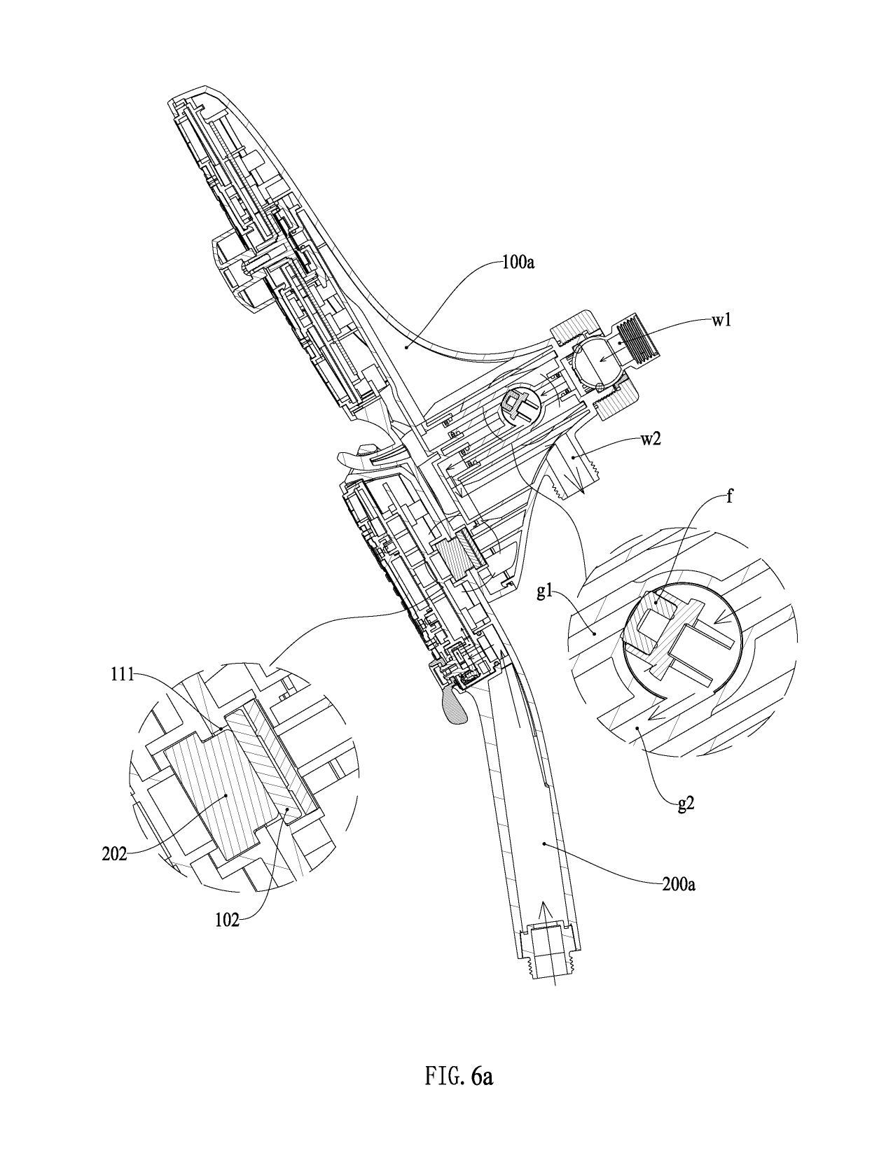

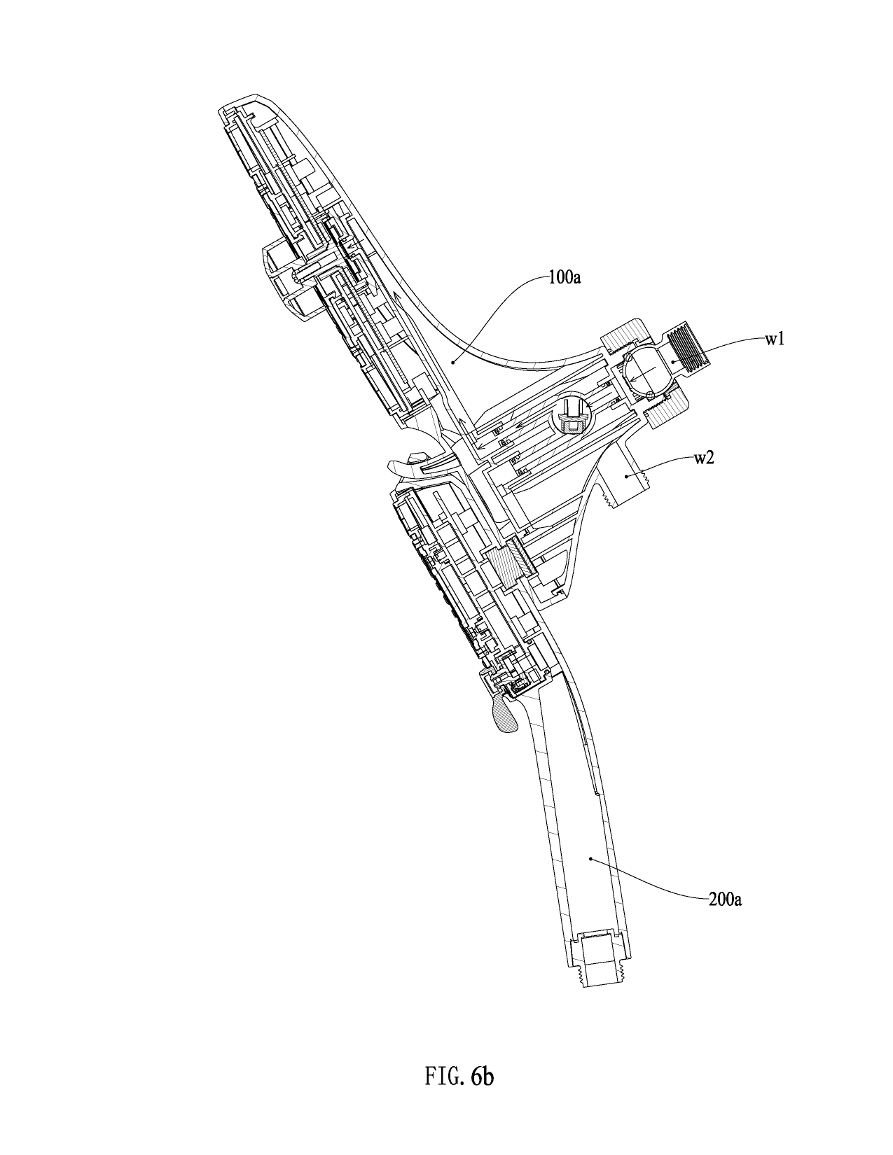

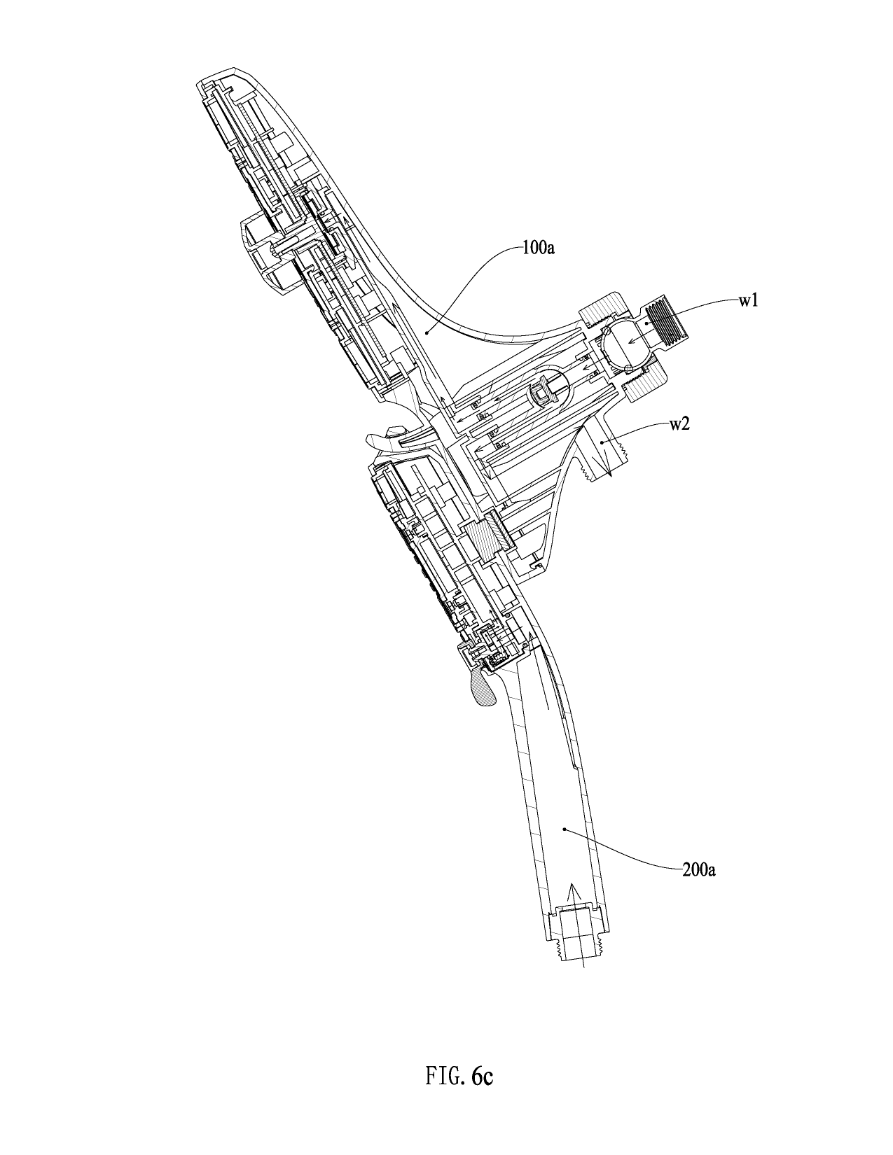

The first housing 110 is provided with a first guide passage 127 and a second guide passage 128 formed by assembling the main housing 112 and the cover 113. Two ends of the first guide passage 127 are respectively connected to the first water outlet passage g2 and the water outlet port w2, thereby forming a U-shaped first water path of "water inlet port w1 - switching chamber - first water outlet passage g2 - first guide passage 127," as shown in FIG. 6A. Two ends of the second guide passage 128 are respectively connected to the second water outlet passage g1 and the water inlet end of the overhead-shower water outlet assembly 120, thereby forming an L-shaped second water path of "water inlet port w1 - switching chamber - second water outlet passage g1 - second guide passage 128," as shown in FIG. 6B. It may be understood that the first guide passage 127 is an extension section of the first water outlet passage g2, and the second guide passage 128 is an extension section of the second water outlet passage g1.

One end of the operating member 1232 extends into the first housing 110 and is drivingly connected to the valve stem 1231, and another end of the operating member 1232 is exposed from a side portion of the connecting portion p12. The valve stem 1231 has a blocking portion f. Sealing rings are respectively sleeved on an outer peripheral wall of the valve stem 1231 on two sides of the blocking portion f. The valve stem 1231 is rotatably disposed in the switching chamber under driving of the operating member 1232. Referring to FIG. 6A, when the blocking portion f closes the second water outlet passage g1 and opens the first water outlet passage g2, water flows from the first water path to the water outlet port w2 and then enters the handheld outlet portion p21 of the handheld showerhead 200a through the connecting conduit 300, so that the handheld showerhead 200a discharges water. Referring to FIG. 6B, when the blocking portion f closes the first water outlet passage g2 and opens the second water outlet passage g1, water flows from the second water path to the overhead outlet portion p11 of the overhead showerhead 100a, so that the overhead showerhead 100a discharges water. Referring to FIG. 6C, when the blocking portion f does not close the first water outlet passage g2 or the second water outlet passage g1, water flows respectively from the first water path and the second water path to the water outlet port w2 and the overhead outlet portion p11 of the overhead showerhead 100a, so that the handheld showerhead 200a and the overhead showerhead 100a simultaneously discharge water. A more detailed water-dividing structure may refer to US 2022/0143631 A1, and is not repeated herein.

In this embodiment, the overhead showerhead 100a has at least two water discharge modes. The overhead-shower water outlet assembly 120 correspondingly has a plurality of first water flow passages. The overhead-shower water outlet assembly 120 further comprises a first mode switching assembly 126 configured to control opening and closing of the plurality of first water flow passages to switch the water discharge mode of the overhead showerhead 100a. The specific structure may refer to the water outlet device disclosed in US 2023/0158516 A1. Alternatively, the overhead showerhead 100a may use a common rotary-disc water path switching structure or a push-button water path switching structure. According to design requirements, a person skilled in the art may also modify the overhead showerhead 100a into a single-function overhead showerhead having only one water discharge mode.

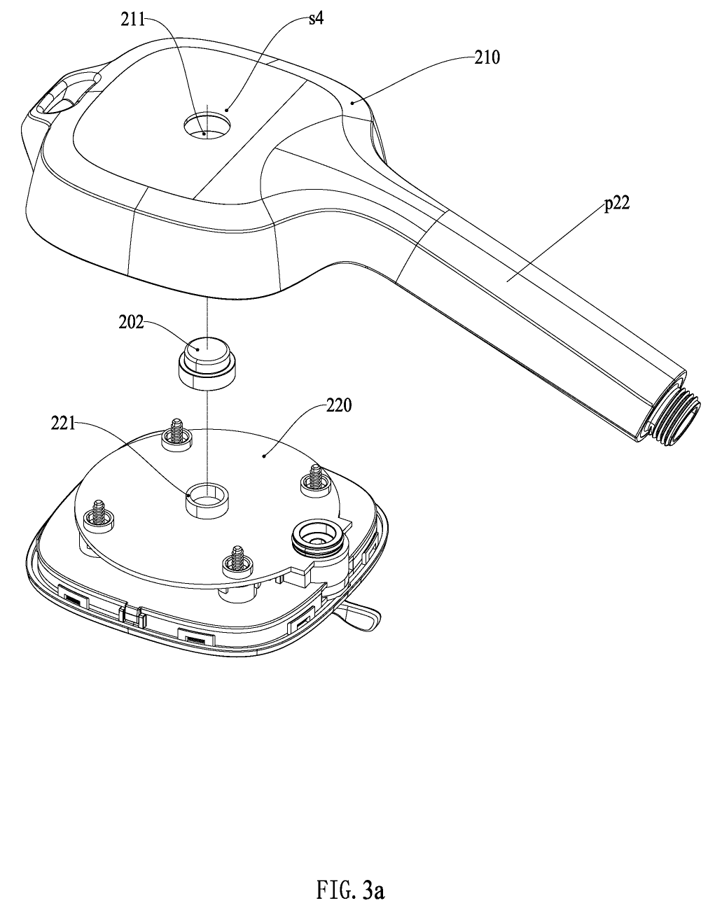

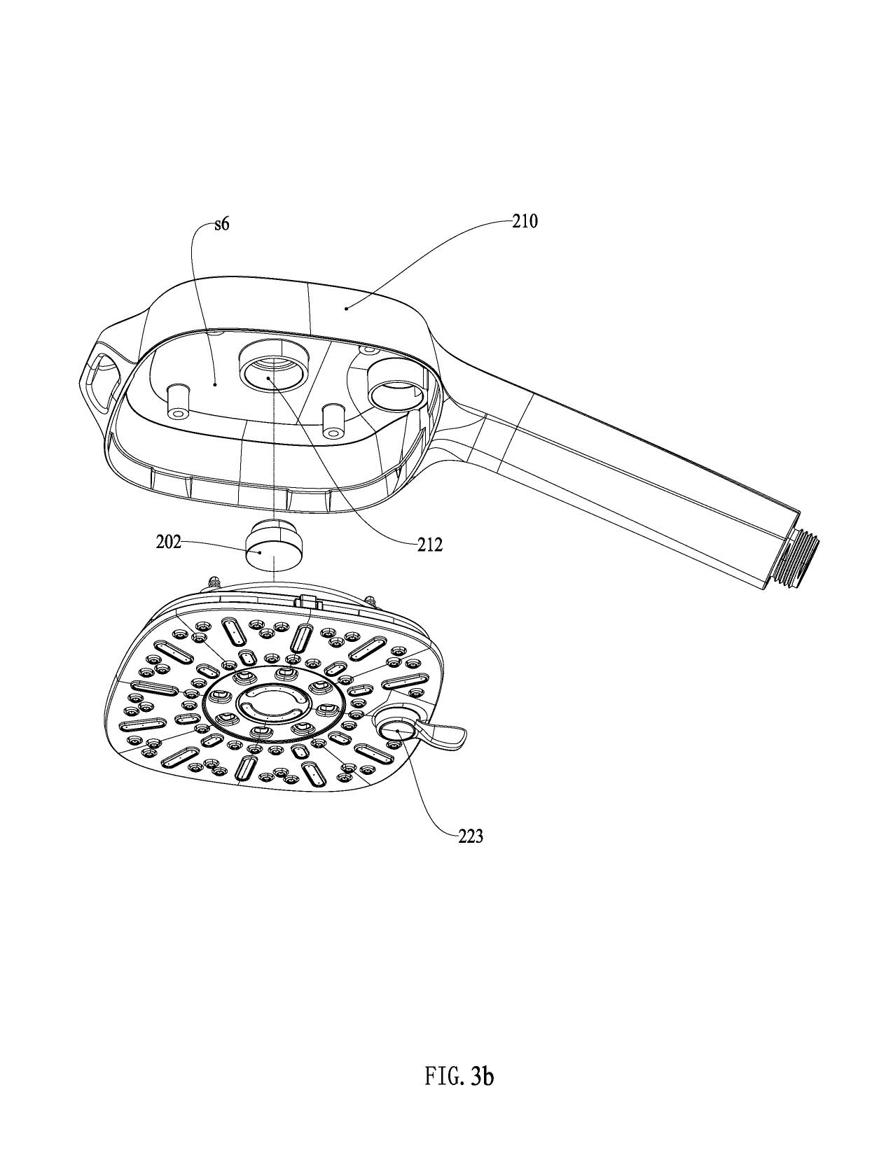

Referring to FIGS. 2A, 2B, 3A, and 3B, in this embodiment, the handheld showerhead 200a comprises a second housing 210 and a handheld-shower water outlet assembly 220. The second housing 210 forms a handle p22 on one side of the handheld showerhead 200a and an handheld outlet portion p21 on another side. The handheld outlet portion p21 is provided with an installation space s6 configured to receive the handheld-shower water outlet assembly 220.

The handheld showerhead 200a is provided, on the back side of the handheld outlet portion p21 of the second housing 210 and at a substantially central position, with a second connecting structure II configured to connect to the overhead showerhead 100a. The second connecting structure II comprises a second magnetic coupling portion p23 and the positioning engagement portion 201a. The first connecting structure I is disposed on the front side of the overhead showerhead 100a, and the second magnetic coupling portion p23 is disposed on the back side of the handheld showerhead 200a.

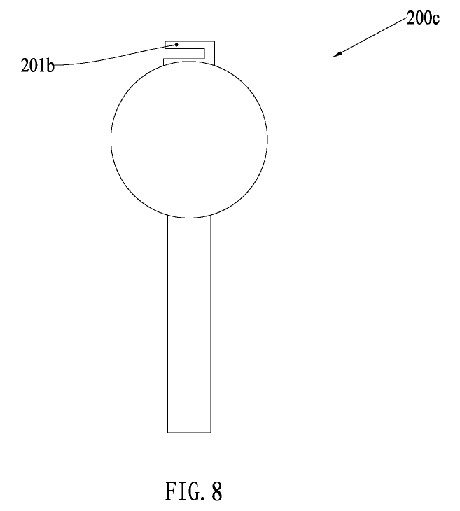

The handheld outlet portion p21 has an outer peripheral wall s2 surrounding a water outlet region s1 of the handheld showerhead 200a. The outer peripheral wall s2 may be understood as a circumferential side wall or peripheral wall portion located at a peripheral edge of the handheld outlet portion p21 of the handheld showerhead 200a and connecting the water outlet surface and the back side of the handheld showerhead 200a. The positioning engagement portion 201a is disposed at an upper portion of the outer peripheral wall s2, so that the positioning engagement portion 201a is visible in the front view. That is, during a process in which the handheld showerhead 200a is moved toward and mounted to the overhead showerhead 100a, the positioning engagement portion 201a is exposed in the user's line-of-sight direction, allowing the user to visually align the positioning engagement portion 201a with the positioning projection 101 of the overhead showerhead 100a. More specifically, the positioning engagement portion 201a is an elliptical through hole formed in the outer peripheral wall s2. Of course, in other embodiments, the positioning engagement portion 201a may alternatively be a C-shaped slot, as shown in FIG. 8.

Referring to FIG. 1, when the handheld showerhead 200a is mounted to the overhead showerhead 100a, the positioning projection 101 extends into the positioning engagement portion 201a, and the free end forms a retaining stop for the positioning engagement portion 201a. Movement of the handheld showerhead 200a relative to the overhead showerhead 100a in upward, downward, leftward, and rightward directions is thereby limited.

The second magnetic coupling portion p23 is disposed at a central position on the back side of the second housing 210 and comprises a second magnetic coupling member 202. The second housing 210 is provided, at a back side opposite the handheld-shower water outlet assembly 220, with a second clearance hole 211. A side of the second housing 210 facing the handheld-shower water outlet assembly 220 is provided with a receiving recess 212, and the second clearance hole 211 communicates with the receiving recess 212. The second magnetic coupling member 202 has a stepped cylindrical structure, and specifically comprises a small-diameter section and a large-diameter section connected to the small-diameter section. The small-diameter section can extend through the second clearance hole 211, the large-diameter section is received in the receiving recess 212, and an inner diameter of the second clearance hole 211 is smaller than an outer diameter of the large-diameter section. A side of the handheld-shower water outlet assembly 220 facing the second clearance hole 211 is further provided with a retaining projection 221. The retaining projection 221 abuts against the large-diameter section to retain the second magnetic coupling member 202 in the receiving recess 212 and to cause the small-diameter section of the second magnetic coupling member 202 to partially protrude through the second clearance hole 211.

In this embodiment, the second magnetic coupling portion p23 and the positioning engagement portion 201a are arranged along a second central axis L2 of the handheld showerhead 200a, as shown in FIG. 2C. When the handheld showerhead 200a is stably connected to the overhead showerhead 100a, the first central axis L1 and the second central axis L2 coincide or substantially coincide in the front view.

The first magnetic coupling member 102 is made of a permanent-magnet material, and the second magnetic coupling member 202 is made of a non-permanent-magnet material capable of being magnetically attracted. According to design requirements, a person skilled in the art may alternatively make the first magnetic coupling member 102 from a non-permanent-magnet material and the second magnetic coupling member 202 from a permanent-magnet material.

Preferably, the second magnetic coupling portion p23 further comprises a second abutting surface s4 formed by the second housing 210 around the second clearance hole 211. The second abutting surface s4 is a planar surface. When the handheld showerhead 200a is mounted to the overhead showerhead 100a, the second magnetic coupling member 202 protrudes from the second clearance hole 211 and extends into the first clearance hole 111, thereby magnetically connecting the first magnetic coupling member 102 and the second magnetic coupling member 202. Meanwhile, the first abutting surface s3 abuts against the second abutting surface s4, making the magnetic connection between the first magnetic coupling portion p14 and the second magnetic coupling portion p23 more stable.

In this embodiment, the handheld showerhead 200a has at least two water discharge modes. The handheld-shower water outlet assembly 220 correspondingly has a plurality of second water flow passages. The handheld-shower water outlet assembly 220 further comprises a second mode switching assembly 223 configured to switch the water discharge mode of the handheld showerhead 200a by controlling opening and closing of the plurality of second water flow passages. The specific structures of the handheld-shower water outlet assembly 220 and the second mode switching assembly 223 are not the focus of protection of the present application. It should be emphasized that a person skilled in the art may also modify the handheld showerhead 200a into a single-function handheld showerhead having only one water discharge mode. The single-function handheld showerhead does not include a mode switching assembly, and its specific structure may refer to numerous existing handheld showerhead products.

### Embodiment 2

Referring to FIG. 7, in this embodiment, a shower system provided by the present disclosure comprises an overhead showerhead 100b, a handheld showerhead 200b, and a connecting conduit 300. This embodiment differs from Embodiment 1 in that the overhead showerhead 100b is a single-function overhead showerhead, and the handheld showerhead 200b is a single-function handheld showerhead. Although the first magnetic coupling portion p14 also comprises a first magnetic coupling member 102, the housing of the overhead showerhead 100b is not provided with an opening corresponding to the first magnetic coupling member 102. Although the second magnetic coupling portion p23 also comprises a second magnetic coupling member 202, the handheld showerhead 200b is not provided with an opening corresponding to the second magnetic coupling member 202. Therefore, two sheets of material are interposed between the first magnetic coupling member 102 and the second magnetic coupling member 202. To ensure that the handheld showerhead 200b is stably magnetically attracted to the overhead showerhead 100b, a magnetic block larger than that of Embodiment 1 may be used.

### Embodiment 3

Referring to FIG. 8, in this embodiment, a shower system provided by the present disclosure comprises an overhead showerhead, a handheld showerhead 200c, and a connecting conduit. This embodiment differs from Embodiment 2 in that the positioning engagement portion 201b on the handheld showerhead 200c is a C-shaped slot having an opening facing left, and does not limit rightward movement of the handheld showerhead 200c relative to the overhead showerhead.

The above embodiments and drawings do not limit the product form or style of the present disclosure. Appropriate changes and modifications made by a person of ordinary skill in the art should be regarded as not departing from the scope of the present disclosure.

What is claimed is:

1. A shower system, comprising:
an overhead showerhead, comprising an overhead outlet portion and a connecting portion arranged side by side, the overhead showerhead having a back side provided with a water inlet port configured to be connected to an external water outlet pipe, the connecting portion having a front side provided with a first connecting structure, the first connecting structure comprising a first magnetic coupling portion and a positioning projection; and
a handheld showerhead, comprising a handheld outlet portion, an outer peripheral wall of the handheld outlet portion, and a second connecting structure configured to connect to the first connecting structure, the second connecting structure comprising a second magnetic coupling portion disposed on a back side of the handheld showerhead and a positioning engagement portion disposed on the outer peripheral wall; and
the positioning engagement portion is exposed to a line of sight of a user while the handheld showerhead is being moved toward and mounted to the overhead showerhead, so that the user can visually align the positioning engagement portion with the positioning projection, and
when the handheld showerhead is mounted to the overhead showerhead, the positioning projection is received in the positioning engagement portion to limit movement of the handheld showerhead relative to the overhead showerhead at least in a vertical direction, and the second magnetic coupling portion is magnetically coupled to the first magnetic coupling portion.

2. The shower system of claim 1, wherein the connecting portion extends downward from a lower portion of a peripheral side of the overhead outlet portion, the back side of the overhead showerhead has a rearwardly protruding portion, and the water inlet port is disposed at an end of the rearwardly protruding portion away from a front side of the overhead showerhead; and
the connecting portion or the rearwardly protruding portion further comprises a water outlet port configured to supply water to the handheld showerhead, the water outlet port being in fluid communication with the handheld showerhead through a connecting conduit; and
the connecting portion or the rearwardly protruding portion further comprises a first switching assembly, the first switching assembly being configured to selectively place the water inlet port in fluid communication with one or both of the water outlet port and the overhead outlet portion.

3. The shower system of claim 2, wherein, in a front view of the overhead showerhead, the water inlet port, the water outlet port, and the first connecting structure are arranged along a first central axis(L1) of the overhead showerhead, the positioning projection is located above the first magnetic coupling portion; and
the second connecting structure is arranged along a second central axis(L2) of the handheld showerhead, the positioning engagement portion is disposed at an upper portion of the outer peripheral wall of the handheld outlet portion, and the second magnetic coupling portion is located below the positioning engagement portion; and
when the handheld showerhead is mounted to the overhead showerhead, the first central axis(L1) and the second central axis(L2) coincide or substantially coincide in the front view.

4. The shower system of claim 1, wherein the positioning projection has a free end extending toward the handheld showerhead, the free end being turned upward; and
the positioning engagement portion is a through hole or a C-shaped slot formed in the outer peripheral wall of the handheld outlet portion, and
when the handheld showerhead is mounted to the overhead showerhead, the positioning projection extends into the positioning engagement portion, and the free end forms a retaining stop for the positioning engagement portion.

5. The shower system of claim 2, wherein the first switching assembly comprises a valve body, a valve stem movably disposed in the valve body, and an operating member at least partially exposed from the connecting portion or the rearwardly protruding portion, the operating member being drivingly connected to the valve stem; and
the valve body has a cylindrical inner chamber and has, at circumferential positions around the inner chamber on an outer-wall side of the valve body, a water inlet passage, a first water outlet passage, and a second water outlet passage respectively in fluid communication with the inner chamber, the water inlet passage being in fluid communication with the water inlet port, the first water outlet passage being in fluid communication with the water outlet port, and the second water outlet passage being in fluid communication with a water inlet end of the overhead outlet portion; and
the valve stem has a blocking portion received in the inner chamber and is configured, under actuation by the operating member, to selectively place the water inlet passage in fluid communication with one or both of the first water outlet passage and the second water outlet passage, so that water from the water inlet port selectively flows to one or both of the water outlet port and the overhead outlet portion.

6. The shower system of claim 2, wherein the overhead showerhead comprises a first housing and an overhead-shower water outlet assembly, and the first housing comprises a main housing and a cover assembled together; and
the main housing and the cover jointly form a housing of the connecting portion on one side of the overhead showerhead and jointly enclose and define a housing of the overhead outlet portion on another side of the overhead showerhead, the housing of overhead outlet portion having a receiving space for the overhead-shower water outlet assembly; and
the main housing forms the rearwardly protruding portion in a region of the connecting portion or in a region of the overhead outlet portion adjacent to the connecting portion, the water inlet port is disposed at an end of the rearwardly protruding portion away from the front side of the overhead showerhead, and a side wall of the rearwardly protruding portion forms the water outlet port extending outward; and
the first magnetic coupling portion comprises a first magnetic coupling member, the first magnetic coupling member is disposed on a side of the cover facing the main housing, and the cover is provided with a first clearance hole corresponding to the first magnetic coupling member; and
the second magnetic coupling portion comprises a second magnetic coupling member, the handheld showerhead comprises a second housing and a handheld-shower water outlet assembly, the second housing is provided, at a back side opposite the handheld-shower water outlet assembly, with a second clearance hole, and the second magnetic coupling member is disposed in the second housing and at least partially protrudes outward through the second clearance hole; and
when the handheld showerhead is mounted to the overhead showerhead, opposing surfaces of the second magnetic coupling member and the first magnetic coupling member are directly magnetically coupled to each other.

7. The shower system of claim 6, wherein the first clearance hole and the positioning projection are both disposed in a region of the cover that forms the connecting portion, the cover has, on a side facing the main housing, a mounting recess surrounding the first clearance hole, the first clearance hole communicating with the mounting recess;
the first magnetic coupling member is circular, the mounting recess is a circular mounting recess adapted to the first magnetic coupling member, the first clearance hole is a circular hole, and an inner diameter of the first clearance hole is smaller than an outer diameter of the first magnetic coupling member; the first magnetic coupling member is disposed in the mounting recess, and a retaining block is disposed in the mounting recess to retain the first magnetic coupling member in the mounting recess; and
the second housing has, on a side facing the handheld-shower water outlet assembly, a receiving recess, the second clearance hole communicating with the receiving recess, the second magnetic coupling member is a stepped cylindrical structure comprising a small-diameter section and a large-diameter section connected to the small-diameter section, the small-diameter section is configured to extend through the second clearance hole, the large-diameter section is received in the receiving recess, and an inner diameter of the second clearance hole is smaller than an outer diameter of the large-diameter section; and
the handheld-shower water outlet assembly has, on a side facing the second clearance hole, a retaining projection, the retaining projection abutting against the large-diameter section to retain the second magnetic coupling member in the receiving recess and to cause the small-diameter section of the second magnetic coupling member to partially protrude through the second clearance hole.

8. The shower system of claim 6, wherein the cover forms a first abutting surface around the first clearance hole, the second housing of the handheld showerhead forms a second abutting surface around the second clearance hole; and
when the handheld showerhead is mounted to the overhead showerhead, the second magnetic coupling member protrudes through the second clearance hole and extends into the first clearance hole, and the first abutting surface abuts against the second abutting surface.

9. The shower system of claim 7, wherein the cover forms a first abutting surface around the first clearance hole,the second housing of the handheld showerhead forms a second abutting surface around the second clearance hole; and
when the handheld showerhead is mounted to the overhead showerhead, the second magnetic coupling member protrudes through the second clearance hole and extends into the first clearance hole, and the first abutting surface abuts against the second abutting surface.

10. The shower system of claim 6, wherein the first magnetic coupling member is made of a permanent-magnet material, and the second magnetic coupling member is made of a non-permanent-magnet material capable of being magnetically attracted.
